(19) United States
(12) Patent Application Publication
(10) Pub. No.: US 2004/0214515 A1
(43) Pub. Date: Oct. 28, 2004

(54) Vehicle mounted game hoist and skinner

(76) Inventors: Joseph Henry Skarlupka IV, Cecil, WI (US); Kara Jean Skarlupka, Cecil, WI (US)

Correspondence Address: JOSEPH H. SKARLUPKA IV., N6593 LAKECREST DRIVE, CECIL, WI, 54111, US

(21) Appl. No.: 10/851,257

(22) Filed: May 21, 2004

Related U.S. Application Data
(63) Continuation-in-part of application No. 10/223,448, filed on Aug. 19, 2002.

(51) Int. Cl. A22B 5/16; A22C 21/00

(52) U.S. Cl. 452/128; 173/184; 452/185

(57) ABSTRACT

A game hoist and skinner apparatus for raising game off the ground and transferring it to a vehicle includes a carriage guide assembly, a sliding carriage assembly, a load attachment means, and a raising mechanism. The carriage guide assembly includes a lower member affixed to a 360° rotating mechanism at one end and a hitch receiver adapter affixed to the opposite end. The sliding carriage assembly includes a horizontal member having a first end opposite a second end, and the first end is affixed to a vertical member that slides along a vertical support between the upper end and the bottom end of the carriage guide. A load attachment means is secured to the second end of the sliding carriage assembly.

### CROSS-REFERENCE TO RELATED APPLICATIONS

This is a continuation-in-part of, and claims priority to, U.S. Serial No. 10/223,448, filed on Aug. 19, 2002.

### BACKGROUND OF THE INVENTION

1. Field of Invention

The present invention relates to devices used for lifting and supporting game animals and other objects for the purpose of skinning and processing, and/or for transferring the object to the vehicle in which the invention is attached by providing a 360° pivoting vertical support member which allows the object to be positioned over the vehicle prior to lowering the object on or into the vehicle.

2. Description of the Prior Art

Throughout history, man has found a need to hunt big game animals for food and sport. Big game in North America typically range in weight from 100 to 500 pounds and more. As is well known by experienced hunters, bagging the game is only half the job. The other half of the job consists of retrieving, skinning and processing the game.

The effort required to secure and transport the carcass after a successful hunt expels a significant toll on the hunter, not to mention the effort required to then skin and process the carcass upon retrieval. When retrieving the carcass there are two practical options: either the hunter must drag the carcass along the ground where it is susceptible to bruising and contamination, or the carcass must be raised off the ground and loaded onto a vehicle and transported. Ideally, the carcass would be loaded onto a vehicle and carried to a more desirable location where the skinning and processing of the carcass can take place in more sanitary conditions. The skinning and processing procedure of the carcass could take place while the carcass is lying on the ground, but again this raises sanitary and health concerns along with the added strain to the hunter himself. Both the skinning and processing is best preformed while the carcass is hanging off of the ground. To date, there have been several devices designed to assist the user in the retrieval and/or skinning and processing of the carcass.

In general, these previous designs can be categorized into one of three groups. The first group consists of devices designed to raise the carcass off of the ground for the sole purpose of assisting the user with the loading of the carcass onto a supporting vehicle. The second group consists of devices designed to raise the carcass off of the ground for the dual purpose of transporting the carcass while it is attached to the device and to assist the user in the skinning and processing of the carcass. The third group consists of devices designed to raise the carcass off of the ground for the dual purpose of transferring the carcass to the supporting vehicle and to assist the user with the skinning and processing of the carcass.

Unfortunately, each of these designs possesses one or more significant deficiency in their design. For example, these designs necessitate a complex attachment means requiring customized attachment bracketry that is costly to manufacture and difficult to use. Most of these devices were designed to fit a specific vehicle type and cannot be transferred from one vehicle type (i.e., a pickup truck) to another type of vehicle (i.e., four-wheeler, ATV) without the addition of the customized bracketry designed for each specific vehicle type. Another deficiency is that some of these devices occupy the cargo area of the supporting vehicle, thereby limiting its usability. Yet another deficiency is that these devices do not raise the carcass to the height required to provide practical assistance during the skinning and processing procedure. Additionally, these devices do not provide lateral support of the raising mechanism or the carcass during the raising and lowering operation. Without lateral support, the raising mechanism and anything attached to it can move and spin freely, thereby providing inadequate control of the connected load. Since this type of apparatus is intended for use in the outdoors where emergency assistance is difficult to receive, the user must be provided with the most secure and stabilized lifting device possible.

Another deficiency with some of these devices is that they utilize one or more pulleys to assist the lifting mechanism, which make the device more costly and is another source of potential mechanical failure. Another deficiency with some of these devices is that they do not provide an additional supporting means from the ground which can be implemented when the connected load is greater than the supporting vehicles load rating. These devices also lack a rotating capability that allows the user to position the carcass over the supporting vehicle prior to lowering it onto the vehicle. Finally, these devices do not allow a user to easily replace the load attachment means on the unit with the one that best accommodates the application of the device. All of the designs disclosed in the prior art could be greatly improved so as to provide the user with a more flexible, safe, stable, cost-efficient, and user-friendly device to lift and support an animal carcass for skinning, processing and/or lifting the animal.

Therefore, what is needed is a vehicle mounted game hoist and skinner that can be easily secured to, and transported by, various types of vehicles, including ATV's, without the need for customized vehicle attachment bracketry. What is further needed is a unit that permits full use of the vehicle cargo space. What is further needed is a unit that will provide the vertical raising capability of the carcass off the ground for proper skinning and processing. What is further needed is a unit that provides lateral stabilizing support of the raising mechanism and connected load throughout the entire vertical travel of the invention which will prevent the connected load from swinging or spinning during the raising and lowering process. What is further needed is a lifting mechanism that is attached to the invention such that it requires no additional pulleys or rollers. What is further needed is a unit that provides a means for activating additional support to the invention from the ground when needed and disengagable when no longer needed. What is further needed is a unit that provides the capability of a 360° rotation of the unit to allow the carcass to be rotated over the vehicle in which the unit is attached prior to lowering the load into the supporting vehicle. What is still further needed is a unit that provides the user the ability to easily attach to the invention the best load attachment means available that will both support and control the intended load.

### BRIEF SUMMARY OF THE INVENTION

It is an object of the present invention to provide a vehicle mounted game hoist and skinner that can be removablly attached to the hitch receiver of any vehicle including an ATV without requiring any additional securing or stabilizing bracketry for the purpose of transporting the unit. It is another object of the present invention to provide full use of the cargo space of the vehicle in which the unit is attached. It is another object of the present invention to utilize a single vertical support member of adequate length so as to provide the required vertical raising of the carcass for proper skinning and processing and to facilitate the loading of the carcass onto the supporting vehicle. It is another object of the present invention to provide the capability of attaching a raising mechanism that can be secured to the invention such that it can be utilized to raise and lower the carcass throughout the full vertical capability of the invention without the need of additional pulleys or rollers. It is another object of the present invention to provide a means of interlocking both, the raising mechanism and the load attachment means, either directly or indirectly, with the vertical support member, in such a way so as to provide full and free vertical (up and down) movement of the invention while at the same time providing lateral support, preventing the raising mechanism and the load attachment means from swinging or spinning during the raising and lowering process. It is another object of the present invention to provide a means for supporting the invention from the ground when needed and to be capable of disengaging such means when it is no longer needed. It is another object of the present invention to provide a 360° rotating capability of the vertical support member that will allow the user to rotate a raised carcass over the supporting vehicle in either direction where it then can be lowered onto and supported by the vehicle. It is another object of the present invention to locate the rotating mechanism of the invention near the ground where it is conveniently accessible by the user and to provide a locking means on the rotating mechanism that will allow the user to lock the mechanism in 90° increments. Yet another object of the present invention is to provide the ability to easily replace the load attachment means with the one that will best suit the purpose in which the invention is being used without affecting the raising mechanism's construction or integrity.

The present invention, the vehicle mounted game hoist and skinner, includes a vertically standing carriage guide assembly, a sliding carriage assembly, a load attachment means, a raising mechanism, and a detachable and rotatable ground support jack. The carriage guide assembly is comprised of a vehicle hitch receiver adapter, a lower horizontal member, and a single vertical support member. The vehicle hitch receiver adapter is used to attach the invention to any vehicle equipped with a tublar style hitch receiver. The sliding carriage assembly is comprised of a horizontal member and a vertical member. The vertical member is attached to one end of the horizontal member and is mechanically interlocked with the vertical support member of the carriage guide assembly. At the opposite end of the horizontal member the load attachment means is attached. The load attachment means is not limited to one type of attachment; different attachment means can be easily interchanged for different applications. The raising mechanism can consist of any manually operated or powered mechanized means for holding the sliding carriage assembly, load attachment means, and therefore connected load in a stationary position along the single vertical support member of the carriage guide assembly when not in operation and will cause the sliding carriage assembly, load attachment means, and therefore connected load to move vertically along the single vertical support member when in motion. The attachment of the raising mechanism to the present invention is an important part of the invention. One end of the raising mechanism is attached to the top portion of the horizontal member of the sliding carriage assembly and the other end is attached to the top portion of the vertical support member of the carriage guide assembly. This provides a laterally supported assistive means for moving the sliding carriage assembly, and therefore the load attachment means, up and down the vertical support member of the carriage guide assembly. The detachable and rotatable ground support jack is removably attached to the lower horizontal member of the carriage guide assembly in such a way so that it can be rotated vertically and locked into position where it then can be manually adjusted to provide ground support to the invention when needed. When no longer needed, the detachable and rotatable ground support jack can either be removed from the invention or rotated 90° horizontally and locked into position where it is held out of the way.

An obvious advantage of this invention is the ability to easily secure the invention to any type of vehicle equipped with a tublar style hitch receiver, which are commonly installed on, or are available for installation on almost all vehicles sold in America today, including pick-up trucks, cars, garden tractors and four-wheelers. The unique ability of this design allows the hitch receiver adapter of the invention to be inserted into the vehicles hitch receiver and locked in place with a single locking pin. The locking pin is provided as part of the hitch receiver and is therefore not considered part of this invention. It is also due to this design that the invention can be installed onto any of these vehicle types or transferred from one type to another without requiring the user to purchase and install any vehicle specific customized bracketry. Another obvious advantage of this invention and it's vehicle attachment design is that it does not take up any cargo space of the supporting vehicle and even allows the tailgate of a standard pickup truck to be lowered and utilized when the invention is in use.

Another obvious advantage of this invention is that the sliding carriage assembly is mechanically interlocked with the single vertical support member of the carriage guide assembly. This unique mechanically interlocked design allows for free up and down movement of the sliding carriage assembly along the carriage guide assembly while at the same time preventing it from turning or spinning around the carriage guide assembly. Another obvious advantage of this invention is the ability to attach a raising mechanism which may include, but is not limited to, hydraulics, electric motor, gears and crank, winch, etc. Another obvious advantage of this invention is that the raising mechanism is attached to both the sliding carriage assembly and the carriage guide assembly, thus allowing it to take advantage of the lateral support given to the sliding carriage assembly. Another obvious advantage of this invention is that the load attachment means is connected to the free end of the sliding carriage assembly, thus allowing it also to take advantage of the lateral support given to the sliding carriage assembly. Another obvious advantage of this invention is the ability to easily attach the best load attachment means necessary for the purpose for which the invention is being used, without modifying the integrity of the raising mechanism. Some load attachment means which could be used with this invention include, but are not limited to, a hook, a gambrel, a sling, a chain, a cargo net, etc.

Another obvious advantage of this invention is the ability to removably attach the vertical support member to the rotating mechanism of the carriage guide assembly with a single locking pin for the purpose of convenient storage. Another obvious advantage of this invention is the length of the single vertical support member which provides the necessary raising capability of the invention required for the proper skinning and processing of game. Another obvious advantage of this invention is the ability of the vertical support member to rotate 360° allowing for the controlled transfer of game to and from the supporting vehicle. Another obvious advantage of this invention is that the rotating mechanism is conveniently located near the ground where it is accessible by the user and provides a locking means in any of four 90° increments with the use of a locking pin. Another obvious advantage of this invention is the ability to removably attach a common detachable and rotatable ground support jack to the base of the carriage guide assembly, which can then provide ground support to the invention relieving the excess weight and stress from any vehicle hitch receiver which is not rated for the applied load. This same detachable and rotatable ground support jack then can be rotated 90° out of the way and locked into position or can be removed from the invention when not required.

Further objects and advantages of the invention will become apparent upon review of the drawings, detailed description of the device, and the appended claims.

### BRIEF DESCRIPTION OF THE SEVERAL VIEWS OF THE DRAWING

A clear understanding of the various advantages and features of the present invention, as well as the construction and operation of conventional components and mechanisms associated with the present invention, will become more readily apparent by referring to the exemplary, and therefore non-limiting, embodiments illustrated in the following drawings which accompany and form a part of this patent specification.

FIG. 1a illustrates a side view of the present invention secured to a vehicle while in the fully lowered position;

FIG. 1b illustrates a side view of the present invention secured to a vehicle while in the fully raised position;

FIG. 1c illustrates a side view of the present invention secured to a vehicle while in the fully raised position and rotated 180°;

FIG. 1d illustrates a side view of the present invention secured to a vehicle while in the lower position and rotated 180°;

FIG. 2a illustrates a front view of the present invention secured to a vehicle in the fully raised position;

FIG. 2b illustrates a front view of the present invention secured to a vehicle in the fully lowered position;

FIG. 3 illustrates a side view of the present invention secured to an alternative vehicle (ATV) in the fully raised position;

FIG. 4a illustrates a side view of the present invention without the vehicle in the fully raised position;

FIG. 4b illustrates a side view of the present invention without the vehicle in the fully lowered position;

FIG. 4c illustrates an exploded side view of the present invention's three main assemblies and two system components;

FIG. 5a illustrates a side view of the carriage guide assembly according to the present invention;

FIG. 5b illustrates an exploded side view of the carriage guide assembly according to the present invention;

FIG. 6a illustrates a side view of the sliding carriage assembly according to the present invention;

FIG. 6b illustrates an exploded side view of the sliding carriage assembly according to the present invention;

FIG. 7a illustrates a side view of the load attachment means according to the present invention;

FIG. 7b illustrates a front view of the load attachment means according to the present invention;

FIG. 7c illustrates an exploded front view of the load attachment means according to the present invention;

FIG. 8 illustrates an exploded side view of the raising mechanism according to the present invention;

FIG. 9a illustrates an exploded side view of the detachable and rotatable ground support jack according to the present invention; and

FIG. 9b illustrates an exploded front view of the detachable and rotatable ground support jack according to the present invention.

### DETAILED DESCRIPTION OF THE INVENTION

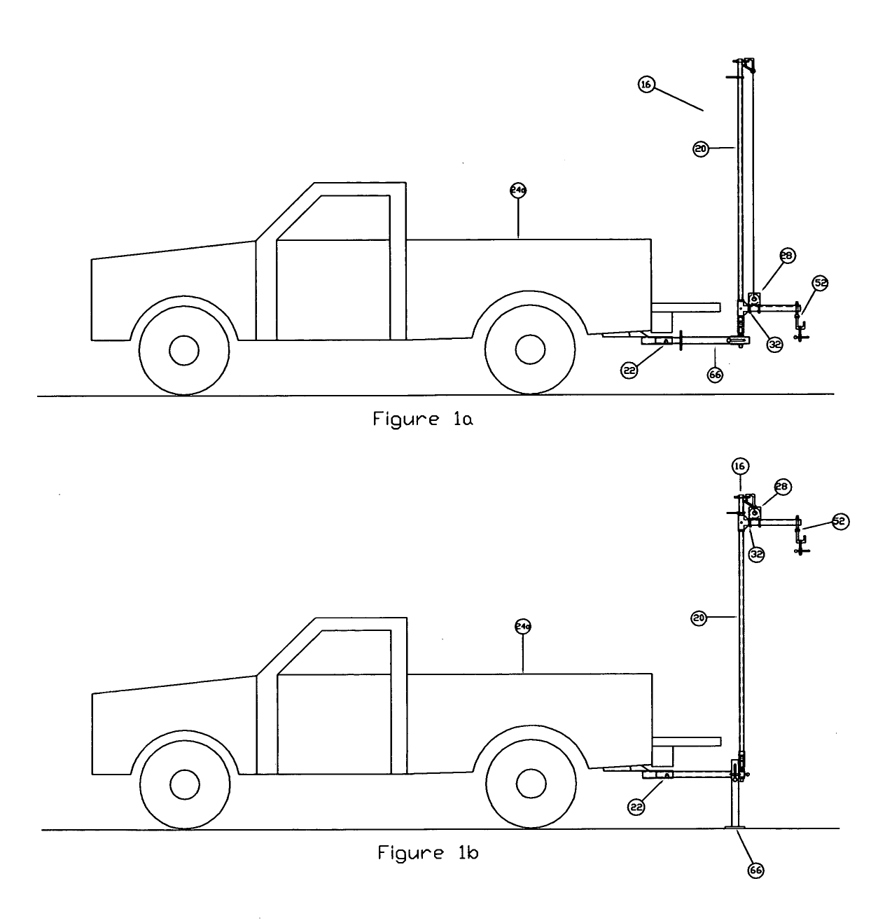

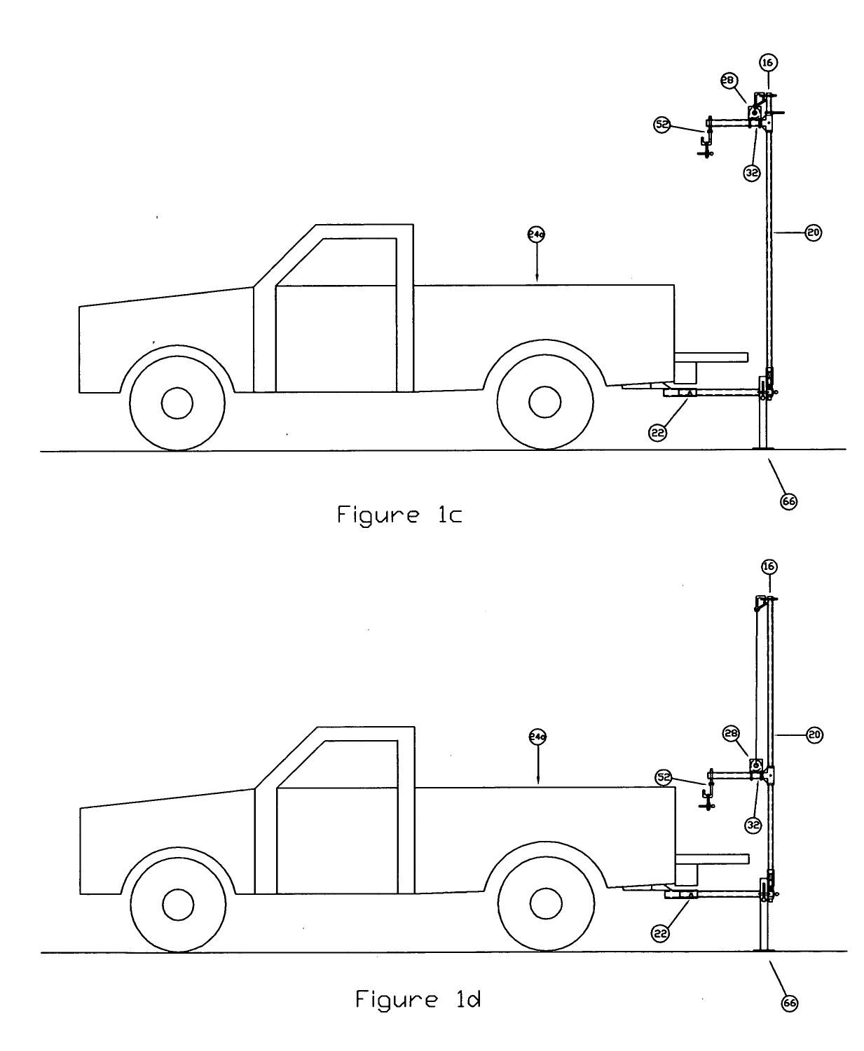

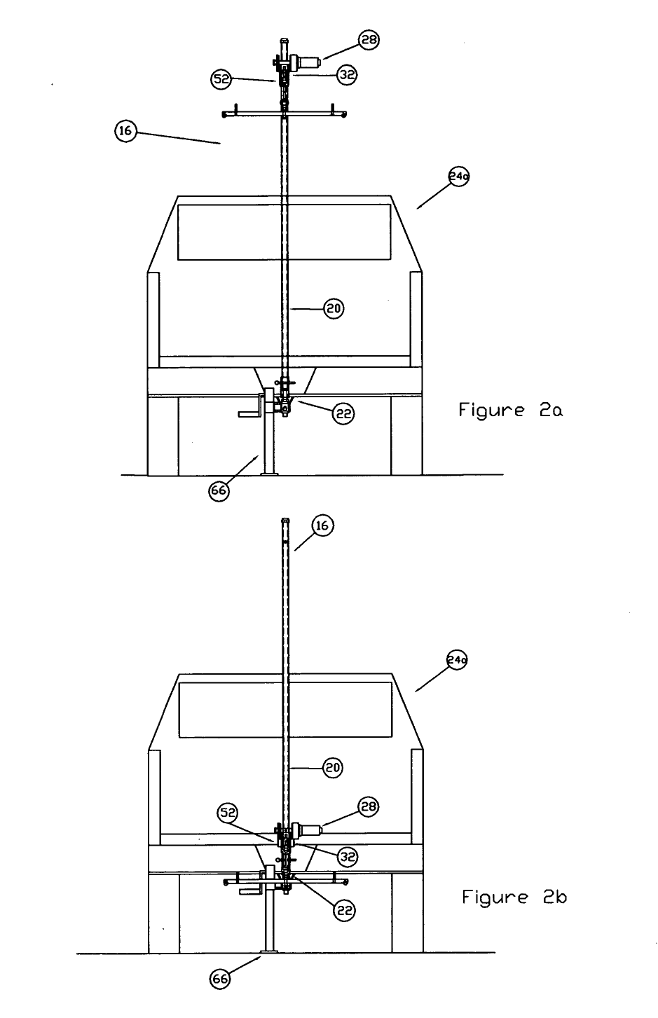

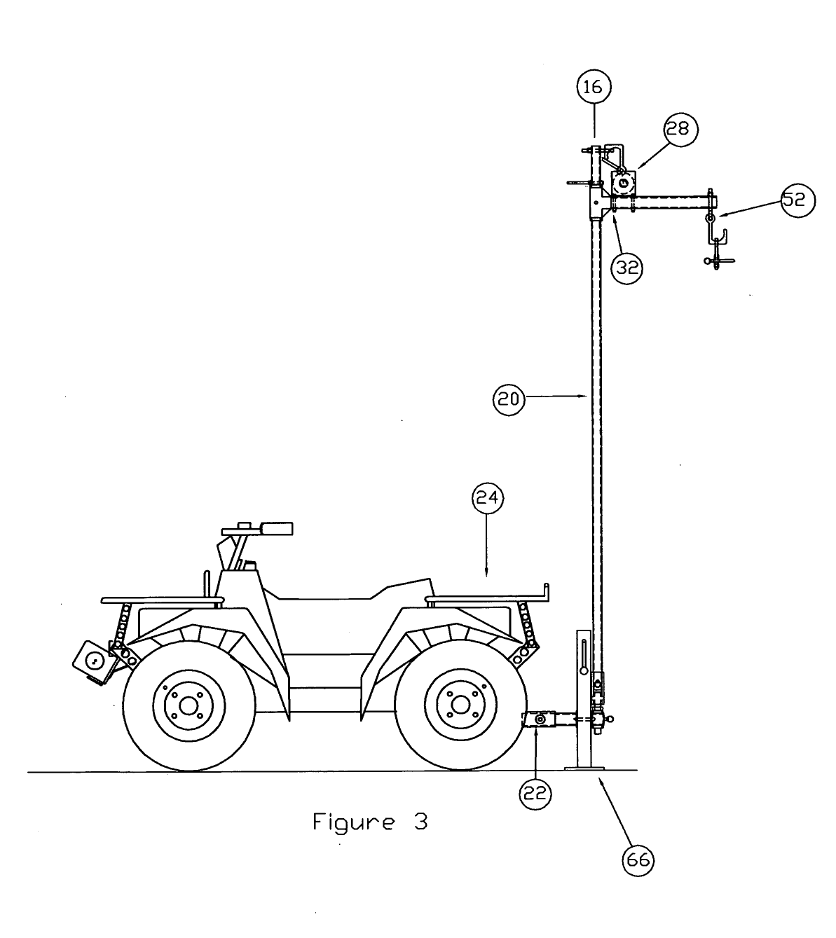

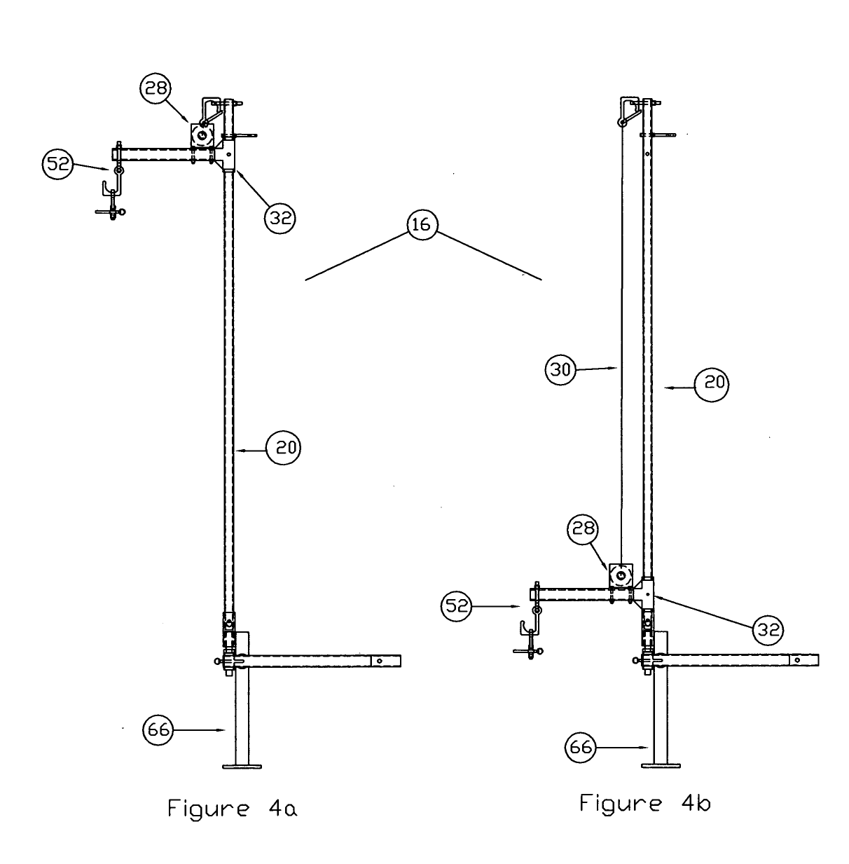

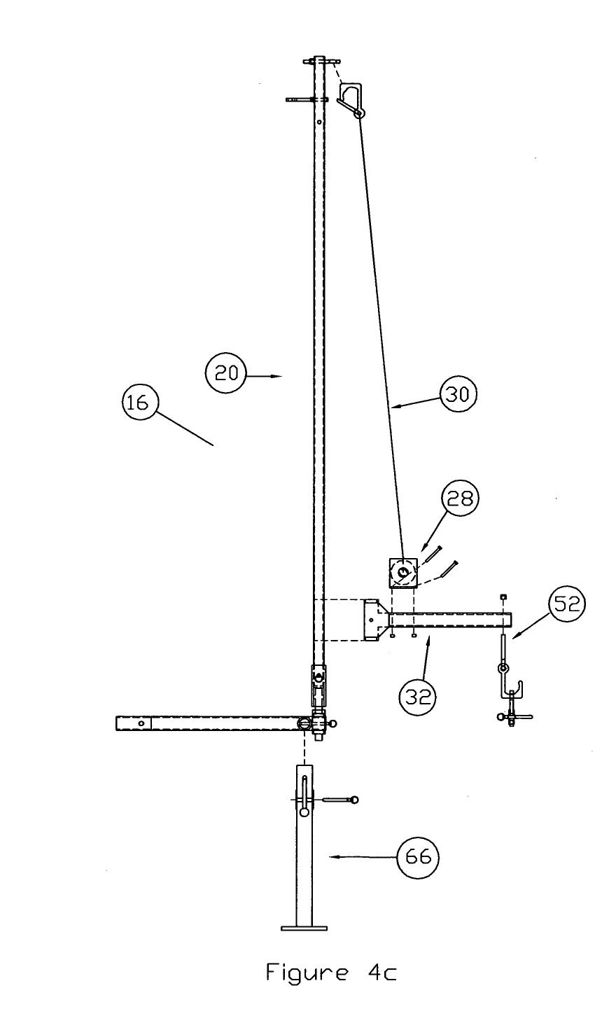

The preferred embodiment of the present invention is illustrated in FIGS. 1 through 9b. FIGS. 1 through 3 show various views of a basic version of a vehicle mounted game hoist and skinner 16 attached to a vehicle—pickup truck 24a and a vehicle—ATV 24 in various states of use. FIGS. 4a and 4b show a side view of a basic version of the vehicle mounted game hoist and skinner 16 without the vehicle in various states of use. FIG. 4c shows an exploded side view of the vehicle mounted game hoist and skinner 16 separating the invention into its three main assemblies; a carriage guide assembly 20, a sliding carriage assembly 32, and a load attachment means 52. FIG. 4c also illustrates a raising mechanism 28, and a detachable and rotatable ground support jack 66.

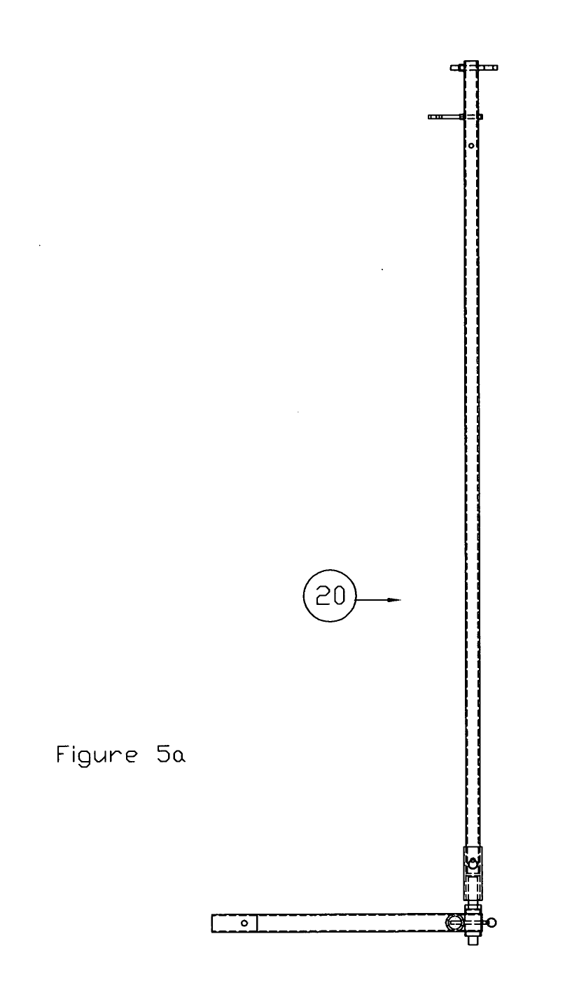

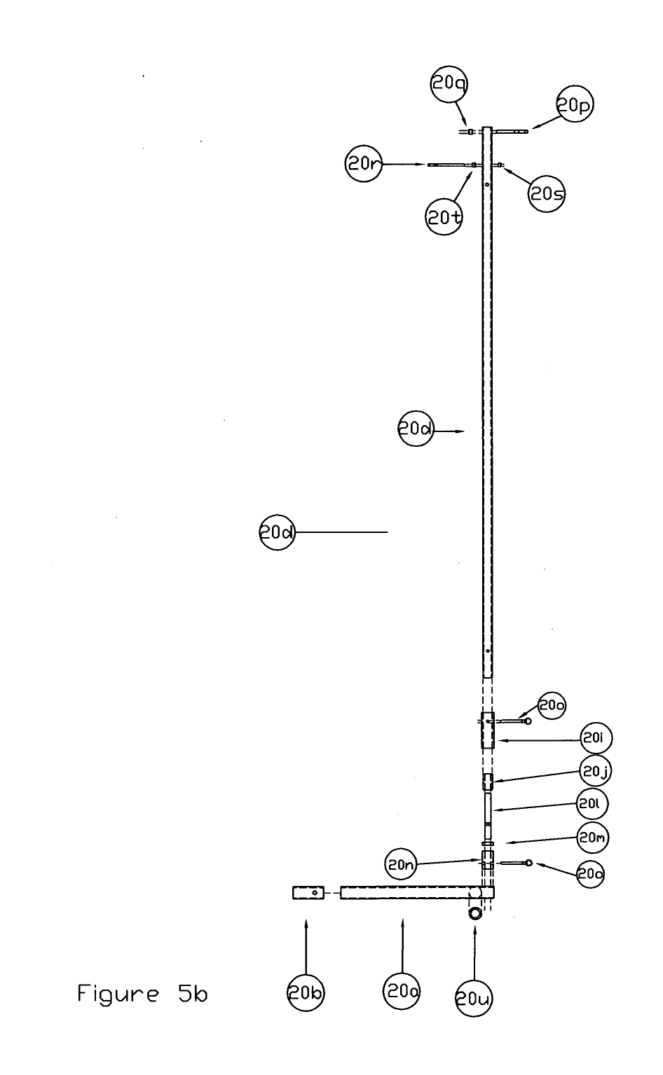

FIG. 5a shows a side view of the carriage guide assembly 20 and FIG. 5b shows an exploded side view of the same assembly. In FIG. 5b, the carriage guide assembly 20 consists of a carriage guide assembly—hitch receiver adapter 20b attached to a carriage guide assembly—lower horizontal support member 20a. The carriage guide assembly—hitch receiver adapter 20b is removably inserted into and supported by a tubular style vehicle hitch receiver 22 of the supporting vehicle. The opposite end of the carriage guide assembly—lower horizontal support member 20a is perpendicularly attached to a carriage guide assembly—rotating shaft receiver 20n. A carriage guide assembly—rotating shaft 20l is inserted into the vertically running hole of the carriage guide assembly—rotating shaft receiver 20n. The carriage guide assembly—rotating shaft receiver 20n has a locking pin through hole machined horizontally perpendicular to the vertical hole in which the carriage guide assembly—rotating shaft 20l resides.

The carriage guide assembly—rotating shaft 20l has two locking pin through holes, each one 90° from the other. These holes are machined horizontally perpendicular to the length of the shaft. To prevent the carriage guide assembly—rotating shaft 20l from falling through the vertical hole of the carriage guide assembly—rotating shaft receiver 20n, a carriage guide assembly—rotating shaft locking collar 20m is attached to the carriage guide assembly—rotating shaft 20l such that the bottom of the carriage guide assembly—rotating shaft locking collar 20m rests on the top of the carriage guide assembly—rotating shaft receiver 20n insuring that the horizontal locking pin holes are vertically aligned in both the carriage guide assembly—rotating shaft receiver 20n and the carriage guide assembly—rotating shaft 20l.

It is this structure that provides the invention with the 360° rotating ability with locking capability at 90° intervals. Attached to the top of the carriage guide assembly—rotating shaft 20l is a carriage guide assembly—vertical support member receiver insert 20j. Attached to the carriage guide assembly—vertical support member receiver insert 20j is a carriage guide assembly—vertical support member receiver 20i. The lower portion of a carriage guide assembly—vertical support member 20d is then removably inserted into the carriage guide assembly—vertical support member receiver 20i and held in place with a carriage guide assembly—locking pin 20o.

The carriage guide assembly—vertical support member 20d is used to both guide and support the sliding carriage assembly 32 throughout the raising and lowering process and is described in more detail later in this section. Near the top of the carriage guide assembly—vertical support member 20d, a carriage guide assembly—sliding carriage assembly stop bolt 20r is attached and secured with a carriage guide assembly—sliding carriage assembly stop bolt nylon lock nut 20s and a carriage guide assembly—sliding carriage assembly stop bolt lock nut 20t. It is the carriage guide assembly—sliding carriage assembly stop bolt 20r that will provide the raising limit of the invention.

At the top of the carriage guide assembly—vertical support member 20d, a carriage guide assembly—raising mechanism linkage bolt 20p is attached and secured with a carriage guide assembly—raising mechanism linkage bolt nylon lock nut 20q. The carriage guide assembly—raising mechanism linkage bolt 20p is used to provide a means for attaching and securing a raising mechanism—Linkage 30 (in this case a powered winch cable) which is described later in this section.

A carriage guide assembly—jack adapter 20u is attached to the vertical side of the carriage guide assembly—lower horizontal support member 20a near the same end of the carriage guide assembly—lower horizontal support member 20a in which the carriage guide assembly—rotating shaft receiver 20n is also attached. The carriage guide assembly—jack adapter 20u is used to provide a means for attaching and securing a detachable and rotatable ground support jack 66 which is described later in this section.

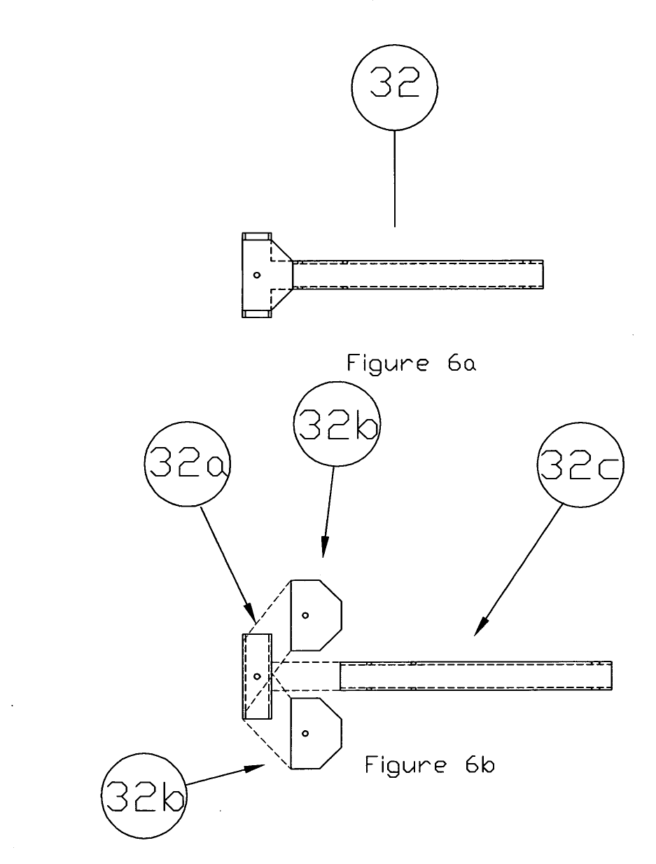

FIG. 6a shows a side view of the sliding carriage assembly 32 and FIG. 6b shows an exploded side view of the same assembly. In FIG. 6b the sliding carriage assembly 32 consists of a sliding carriage assembly—vertical member 32a perpendicularly attached to one end of a sliding carriage assembly—horizontal member 32c. A sliding carriage assembly—stiffener gusset 32b, which there are two, is attached to each vertical side of the perpendicular intersection of the sliding carriage assembly—vertical member 32a and the sliding carriage assembly—horizontal member 32c.

The sliding carriage assembly—vertical member 32a is constructed of a non-circular tublar material of the same shape of that which the carriage guide assembly—vertical support member 20d is constructed except that the inside dimension of the sliding carriage assembly—vertical member 32a is slightly larger than the outside dimension of the carriage guide assembly—vertical support member 20d.

The sliding carriage assembly 32 is interlocked with the carriage guide assembly—vertical support member 20d by inserting the carriage guide assembly—vertical support member 20d into and through the sliding carriage assembly—vertical member 32a prior to its insertion into the carriage guide assembly—vertical support member receiver 20i as described earlier in this section.

This interlocking means allows the sliding carriage assembly—vertical member 32a (and therefore the sliding carriage assembly 32) to freely slide vertically, up and down, along the carriage guide assembly—vertical support member 20d while at the same time member 32a is prevented from turning or spinning laterally around the carriage guide assembly—vertical support member 20d due to the non-circular shape of the tublar structure of each.

The interlocking means between the sliding carriage assembly—vertical member 32a and the carriage guide assembly—vertical support member 20d described herein as a single tube within a single tube, is one embodiment of interlocking means, but it should be understood that this same interlocking capability can also be accomplished utilizing more complex machining tactics, including but not limited to, machining slots, groves, or utilizing shapes made from extruded or molded materials in combination with the use of additional mechanical components such as, but not limited to, cam followers, rollers, roller bearings, etc.

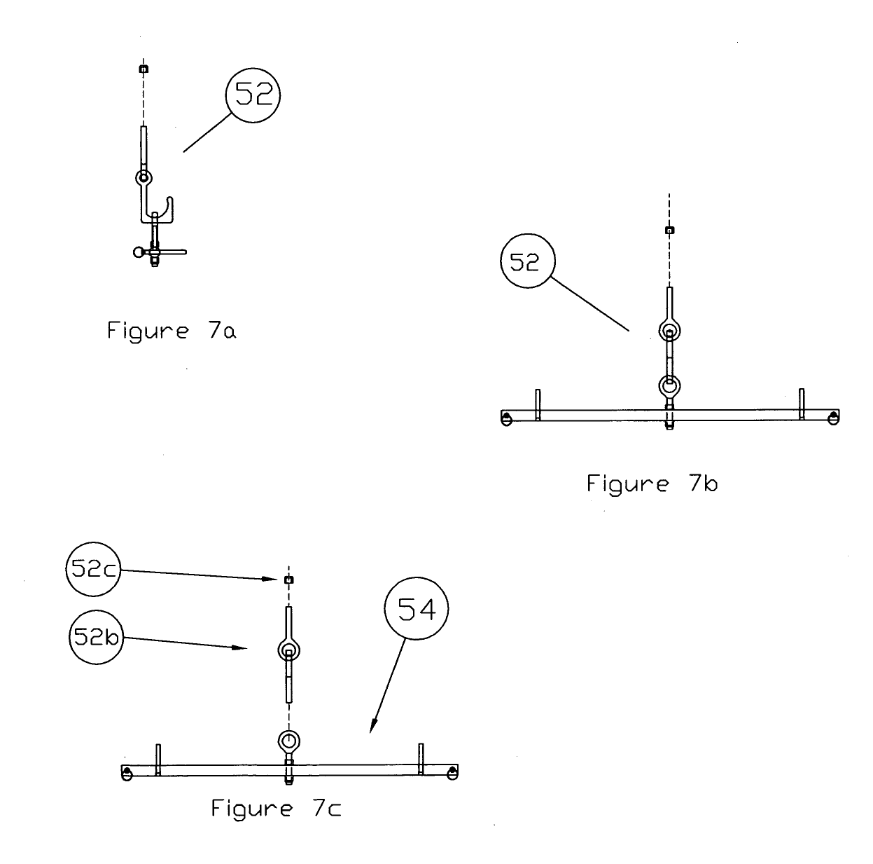

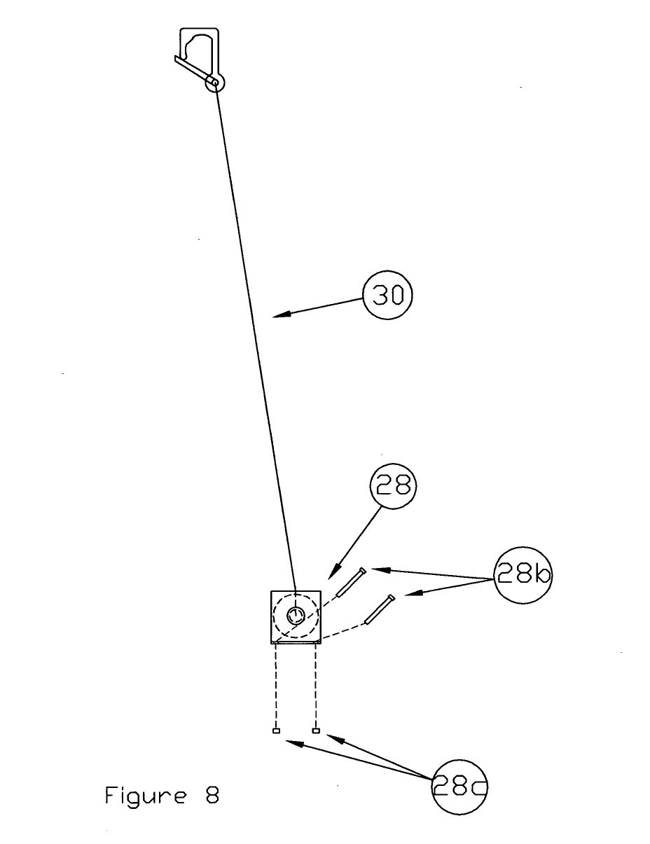

FIG. 7a shows a side view of the load attachment means 52, FIG. 7b shows a front view of the load attachment means 52, and FIG. 7c shows an exploded front view of the same assembly. In FIG. 7c, the load attachment means 52 consists of a load attachment means—attachment eyebolt with hook 52b which is attached to the opposite end of the sliding carriage assembly—horizontal member 32c from that which is attached to the sliding carriage assembly—vertical member 32a and secured with a load attachment means—attachment nut 52c.

The load attachment means—attachment eye bolt with hook 52b is used to provide a means for attaching and securing the load to be raised and is easily replaced by the user with another device which is deemed more suitable for the application for which it is being used. All three FIGS. 7a, 7b and 7c also illustrate the load attachment means 52 connected to a skinning gambrel 54.

FIG. 8 shows an exploded side view of the raising mechanism 28, which in this case is a powered winch. In FIG. 8 the powered winch 28 is attached to the top of the sliding carriage assembly—horizontal member 32c by a raising mechanism—attachment bolt 28b, of which there are two, and secured with a raising mechanism—attachment nylon lock nut 28c, of which there are also two. A raising mechanism linkage 30, which in this case is a powered winch cable with hook, is connected at one end to the powered winch 28 and at the other end to the carriage guide assembly—raising mechanism linkage bolt 20p via the hook.

It should be understood that the powered winch 28 and its associated powered winch cable with hook 30 could be replaced with a multitude of other mechanical devices designed and built to assist in the raising and lowering process of the invention. It should also be understood that regardless of which one of the available raising mechanisms 28 are used on the invention, if it interlocks the sliding carriage assembly 32 with the top portion of the carriage guide assembly 20 without the need or usage of any other mechanical means it is incorporated into the preferred embodiment of the present invention.

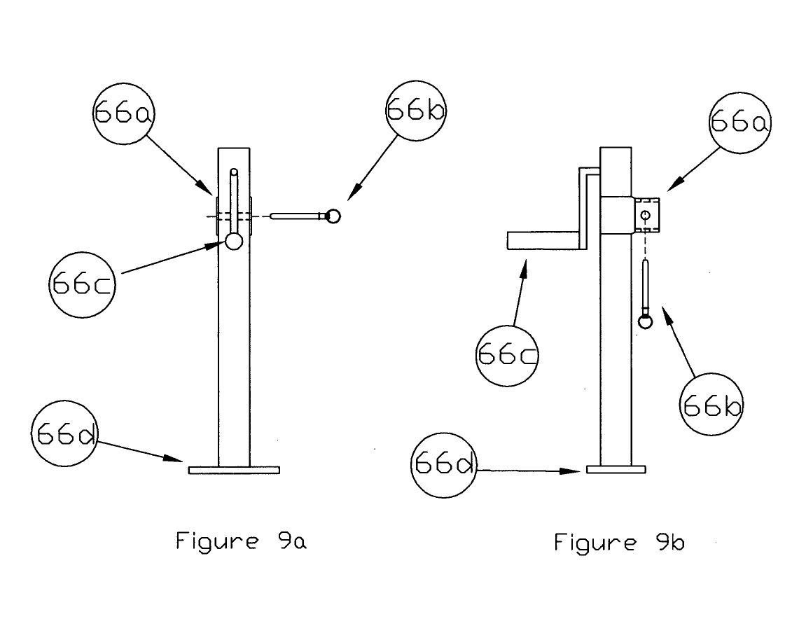

FIG. 9a illustrates a side view of the detachable and rotatable ground support jack 66 and FIG. 9b illustrates a front view of the same assembly. The detachable and rotatable ground support jack 66 shown in FIGS. 9a and 9b depict a commonly available trailer jack and is not considered part of this invention.

The attachment means, however, is a component of the present invention. In particular, the trailer jack 66 is equipped with a detachable and rotatable ground support jack—rotating attachment sleeve 66a which is inserted over and around the carriage guide assembly—jack adapter 20u and held in a vertical position with a detachable and rotatable ground support jack—attachment sleeve locking pin 66b that is provided as a part of the trailer jack 66. After jack 66 is installed, a user manually turns a detachable and rotatable ground support jack—hand crank 66c which, in turn, causes a detachable and rotatable ground support jack—extendable foot plate 66d to extend, eventually making contact with the ground's surface relieving most of the weight and stress experienced by the supporting vehicle during the raising processes of the present invention when required by a supporting vehicle which has a lower load rating than that of the applied load which is to be raised by the present invention.

When or if the supporting ability of the trailer jack 66 is no longer needed, the user retracts the detachable and rotatable ground support jack—extendable foot plate 66d by turning the detachable and rotatable ground support jack—hand crank 66c in the opposite direction sufficiently so as to allow the trailer jack 66 to be unlocked and either rotated 90° and relocked in a horizontal position or removed completely.

The scope of the application is not to be limited by the description of the preferred embodiments described above, but is to be limited solely by the scope of the claims that follow. For example, instead of a rotating carriage guide assembly, a non-rotating carriage guide assembly could be utilized without departing from the scope of the preferred embodiment of the present invention.

I hereby claim:

1. A hoist and skinner apparatus for raising game off the ground and transferring the game to a vehicle comprising:
a carriage guide assembly including a lower horizontal member having a first end opposite a second end, and a single vertical support having an upper end and a bottom end, wherein the bottom end of the vertical support is adjacent to the second end of the lower horizontal member, and wherein the vertical support includes a rotating shaft removably secured to the bottom end of the vertical support;
a sliding carriage assembly including a horizontal member having a first end opposite a second end, wherein the first end is affixed to a vertical member, the vertical support of the carriage guide assembly is substantially received within the vertical member and the vertical member slides along the vertical support between the upper end and the bottom end; and
a load attachment means removably secured to the second end of the sliding carriage assembly.

2. The apparatus according to claim 1, further comprising a raising device including a stationary unit and a movable linkage wherein the stationary unit is affixed to the first end of the sliding carriage assembly, and the movable linkage is removably secured to the upper end of the vertical support of the carriage guide assembly.

3. The apparatus according to clam 2, wherein the raising device is a powered winch.

4. The apparatus according to claim 1, wherein the carriage guide assembly rotates 360°.

5. The apparatus according to claim 4, wherein a locking pin affixes the carriage guide assembly in 90° lockable increments.

6. The apparatus according to claim 5, wherein the rotating shaft is between a receiver insert and a locking collar, wherein the locking collar is attached to the rotating shaft and rests on top of a rotating shaft receiver.

7. The apparatus according to claim 6, wherein the rotating shaft is locked with the locking pin that is inserted into the rotating shaft receiver.

8. The apparatus according to claim 6, wherein the rotating shaft is locked with the locking pin that is inserted into a vertical support member receiver.

9. The apparatus according to claim 1, wherein the load attachment means further comprises an eyebolt with a hook.

10. The apparatus according to claim 1, wherein the carriage guide assembly further comprises a hitch receiver adapter affixed to the first end of the lower horizontal member.

11. The apparatus according to claim 10, wherein a hitch pin affixes the hitch receiver adapter to the hitch receiver on the vehicle.

12. The apparatus according to claim 1, wherein the upper end of the single vertical support of the carriage guide assembly includes a sliding carriage assembly stop bolt.

13. The game apparatus according to claim 1, wherein the lower horizontal member of the carriage guide assembly includes a detachable and adjustable trailer jack.

14. A hoist and skinner apparatus for raising game off the ground and transferring the game to a vehicle comprising:
a carriage guide assembly including a lower horizontal member having a first end opposite a second end, and a single vertical support having an upper end and a bottom end, wherein the bottom end of the vertical support is adjacent to the second end of the lower horizontal member, and wherein the vertical support includes a rotating shaft secured to the bottom end of the vertical support;
a sliding carriage assembly including a horizontal member having a first end opposite a second end, wherein the first end is affixed to a vertical member, the vertical support of the carriage guide assembly is substantially received within the vertical member and the vertical member slides along the vertical support between the upper end and the bottom end; and
a load attachment means secured to the second end of the sliding carriage assembly.

15. The apparatus according to claim 14, wherein the rotating shaft is removably secured to the bottom end of the vertical support.

16. The apparatus according to claim 14, wherein the load attachment means is removably secured to the second end of the sliding carriage assembly.

17. The apparatus according to claim 14, further comprising a raising device including a stationary unit and a movable linkage wherein the stationary unit is affixed to the first end of the sliding carriage assembly, and the movable linkage is secured to the upper end of the vertical support of the carriage guide assembly.

18. The apparatus according to claim 17, wherein the movable linkage is removably secured to the upper end of the vertical support of the carriage guide assembly.

19. A hoist and skinner apparatus for raising game off the ground and transferring the game to a vehicle comprising:
a carriage guide assembly including a lower horizontal member having a first end opposite a second end, and a single vertical support having an upper end and a bottom end, wherein the bottom end of the vertical support is adjacent to the second end of the lower horizontal member, and wherein the vertical support includes a rotating shaft secured to the bottom end of the vertical support;
a sliding carriage assembly including a horizontal member having a first end opposite a second end, wherein the first end is affixed to a vertical member, the vertical support of the carriage guide assembly is substantially received within the vertical member and the vertical member slides along the vertical support between the upper end and the bottom end;
a load attachment means secured to the second end of the sliding carriage assembly; and
a raising device interlocked with the horizontal member of the sliding carriage assembly.

20. The apparatus according to claim 19, wherein the raising device further comprises a powered winch having a stationary unit and a movable linkage wherein the stationary unit is affixed to the first end of the sliding carriage assembly, and the movable linkage is secured to the upper end of the vertical support of the carriage guide assembly.
